(19) United States
(12) Patent Application Publication
(10) Pub. No.: US 2003/0067769 A1
(43) Pub. Date: Apr. 10, 2003

(54) Multiple LED light source

(76) Inventor: Scott Gilpin, Escondido, CA (US)

Correspondence Address: David T. Bracken, The Law Office of David T. Bracken, 4839 Bond Avenue, Orange, CA, 92869, US

(21) Appl. No.: 09/974,695

(22) Filed: Oct. 10, 2001

(51) Int. Cl. F21L 4/02

(52) U.S. Cl. 362/184; 362/197; 362/250; 362/251; 362/105

(57) ABSTRACT

The present invention comprises a plurality of new high intensity LED's activatable by the user or by logic means to provide long life and adequate small battery-powered area lighting for a user, preferably hand held or mountable on the head of the user to permit hands-free directable illumination.

### BACKGROUND OF THE INVENTION

The present invention relates to small or handheld and battery powered light sources for lighting an area about a user.

The prior art comprises various hand held flashlights, such light sources being adapted to be mounted on hard hats for work in darkened places such as mines and darkened rooms. Although the prior art devices have been effective, they are only effective for a relatively short time, i.e., only as long as the batteries last.

There is a substantial need for a user to have one or an easily accessed multiplicity of devices such that the user of forehead mounted devices for lighting the users view may have available a range of types and intensities of illumination for the field of view, thereby placing at the user's option a choice of high intensity illumination and short battery life or lengthening the battery life by choosing adequate but reduced illumination.

### SUMMARY OF THE INVENTION

The present invention comprises a plurality of new high intensity LED's activatable by the user or by logic means to provide long life and adequate small battery-powered area lighting for a user, preferably hand held or mountable on the head of the user to permit hands-free directable illumination.

The flexibility of the present invention is improved by an embodiment whereby the LED light source mounted on an LED support is replaceable with a filament type bulb in a prior art parabolic reflector support. A supporting or non-supporting plug connects the LED light source connections to a switching/logic means which is in turn connected to a battery power source. The plug permits removal of the LED light source for other light sources with more or less or colored LED's or with the filament type bulb assembly, or, in yet another embodiment of the invention, the LED light source assembly is removable to a handheld device with a similar plug, switching/logic means and battery so that the LED light source may also be a handheld flashlight as well as a forehead supported light source.

The present invention comprises the concepts of a plurality of high intensity LED's supportively mounted on an LED support, whereafter electrical connections for the LED's are adapted to be switchably connected with battery power through the switching/logic means. The switching/logic means may permit switching of sequentially one at a time or all at once the LED's by user manipulation, whereby the sequential and all-at-once functions may be incorporated into the same switching/logic means. The switching/logic means may comprise digital logic means for performing a range of functions such as timed sequential turning on or off of the LED's (in one form, where the switching/logic means comprise means for sensing battery power and reducing lighted LED's in response thereto), flashing LED's all together or in a pattern for an entertainment or emergency display. It is well known in the art to provide clock, switching and programmable means on a small circuit board to accomplish the above functions of the switching/logic means, although some may be achieved with simple electrical contacts switchable on and off by user manipulation, such as rotation of a cup-like LED support housing relative to a housing for the battery and switching/logic means which is then strapwise connected with the user's forehead.

The present invention also comprises providing on the LED support a filament, noble gas or halogen type bulb so that the user may, though the switching/logic means, select for lighting either or both the filament/noble gas/halogen bulb or the LED's, providing immediate brighter and more power consuming lighting via the filament/noble gas/halogen bulb or the lower and more diffuse lower power LED lighting. The supports for the LED lighting and the combination of LED lighting with filament, noble gas or halogen lighting preferably directs the illumination to a forward plane. A typical incandescent lamp operates on 5 volts and uses a current of 115 milliamps (although a halogen bulb will operate at about 550 milliamps) while a LED can operate on 3 volts and draw current on the order of 5-30 milliamps. The low power requirements have led skilled persons to consider using LED's as signal lamps in combination with reflectors or Fresnel type lenses, although no prior device has resulted in delivering sufficient LED array illumination for a work or recreation environment.

The present invention comprises means for providing LED lighting for medical and surgical environments (including disposable items), low hazard, low voltage lighting for Class 1 explosive environments, low cost (including disposable items) lighting for nuclear or other environments when disposal of the light source and housing is desirable, and LED lighting for workers in the electrical and mining industries. The invention also comprises switches, timing and logic means which turn the LED and other lights on or off in a predetermined or selectable sequence according to the needs of a particular worker or user. For instance, each of a series of photosensitive diodes having decreasing sensitivity to incident ambient light may control switching off of each of the respective set of LED's as in the invention such that as the user moves from an area of high to low illumination, the LED's of the invention turn on one at a time maintaining relatively constant illumination for the user.

One of the critical benefits of the invention is reduced power for effectively equivalent lighting using the invention LED's optionally with incandescent, noble gas or halogen bulbs. It is known in the art of circuit design and logic means to provide for circuits which measure power usage compared with available battery power to determine available device operation time. The output of those comparison means can be used to automatically reduce the number of lighted LED's to preserve lighting of at least one LED in the invention lighting device for a predetermined period of time, i.e., such as where a user may not be left with sufficient light to complete a task but is left with sufficient light to move from the darkened area. Such comparison means may also activate an audible or visual signal for low battery power to the user.

The present invention switching means may also comprise a spring switch for turning off or on all the LED's at once to permit emergency or Morse code signalling.

### BRIEF DESCRIPTION OF THE DRAWINGS

FIGS. 1 and 2 are respectively perspective and front views of an embodiment of the invention high intensity LED device mounted on a mannequin head with and without a hat.

FIG. 3 is a general schematic of the invention having an LED support optionally replaceable with another light source support.

FIG. 4 is the schematic of FIG. 3 having replaced the LED support with a filament type light and support.

FIG. 5 is a side cutaway view of adjacent high intensity LED's mounted on a support plane.

FIG. 6 is a cutaway protective cove perspective view of the device of FIGS. 1 and 2 showing overlap of illumination cones for unidirectional and adjacent LED's.

### DETAILED DESCRIPTION OF THE INVENTION

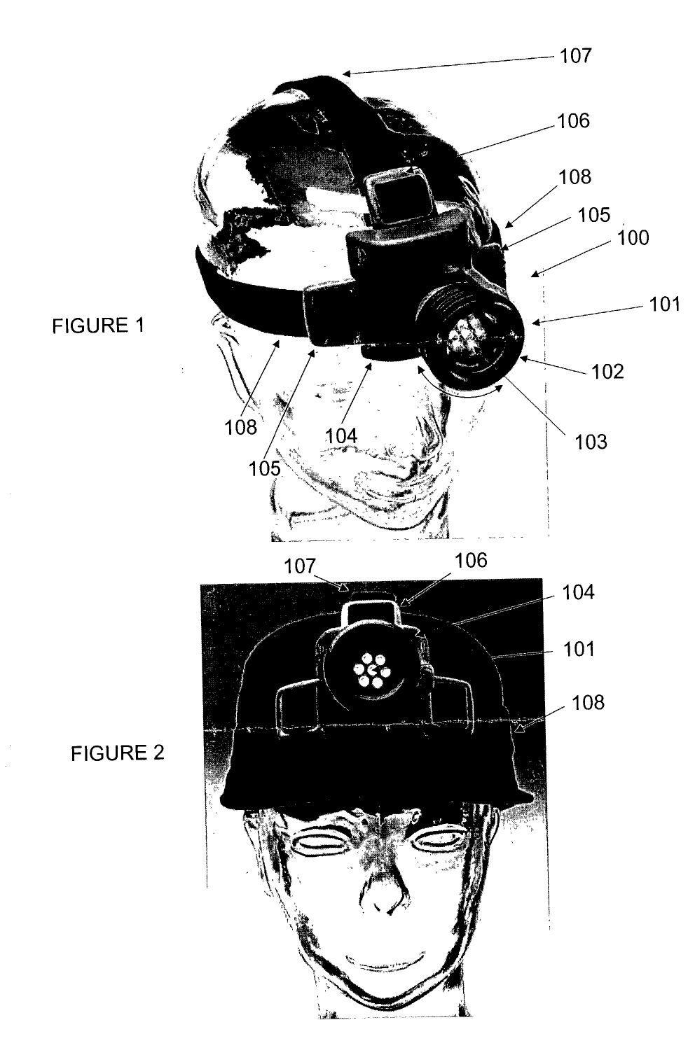

The invention is now described with reference to the figures. The invention device 100 of FIGS. 1 and 2 comprises an LED light source 101 comprising rotatable housing and LED support means 102, rotation clockwise or counterclockwise about its axis causing the LED's 103, in a first invention sequence, to switch sequentially on or off. Casing 104 supportively connects to light source 101 and contains the batteries and circuitry to effect the objects of the invention as to the power and switching functions described therefore. Casing 104 further comprises extensions 105 and 106 adapted to retain free ends of straps 108 and 107 respectively, thereby permitting secure mounting of the invention device 100 to the cap-less or capped human head at about the forehead so that the LED's 103 illuminate the user's field of vision according the a user-selectable intensity. The plurality of LED's are directed such that the axes of their beam cones are generally parallel to each other, the LED's themselves being mounted in a support plane adapted to maintain the LED's in such a relationship.

In operation, the user will merely reach to the forehead area and turn means 102 to the right or left, so long as either direction, for this first invention sequence, is adapted in the circuitry and contacts such that one direction sequentially powers or turns off the LED's one at a time. LED's for the invention are preferably those such as are available from the manufacturer Nichia Chemical Industries Ltd. (Tokushima-ken, Japan), Catalog Number NSPW500BS (5600 mcd white, 15-18 lumens per watt at 20 mA, 5.6 candela 20 degree beam, gallium nitride and indium gallium nitride LED), i.e., high intensity LED's, a plurality thereof capable of lighting a vertical surface 30-50 feet away from a user of the invention device such that dark lettering on a light background thereon in an entirely otherwise dark room is as legible as if the room light were at normal illumination levels. It has been found that the embodiments of FIGS. 1 and 2 comprise a preferred form of the invention as to the number of LED's to be used therein. The devices of FIGS. 1 and 2 show seven LED's mounted generally side by side in a plane and adapted to be fixed in device 100 such that the LED's are directed such that they illuminate the wearer's field of vision in a darkened area. The darkened area need not be enclosed—a user walking at night in a darkened area such as hiking in a wilderness area will find that the selectablity of illumination from lighting more or fewer of the LED's will preserve essential battery life balanced against illuminating only to a desired degree the path in front of the user.

The nature of LED illumination has been expressed by the prior art inadequate for such critical applications as illuminating a user's path for walking or illuminating the area in front of a user for essential operations such as mechanical or electrical repair work. The present invention comprises a device 100 having just such capability but endowed also with having variable illumination that preserves battery life. It has been dramatically found that the even illumination of LED lighting in the invention device is superior than filament generated illumination as far as reduced power requirements for a wider illumination viewing range. In the embodiment of FIGS. 1 and 2, three AA batteries are the sole power source for the seven LED's 103, where a preferable LED for the invention comprises a relatively high intensity LED having a current use of about or less than 30 milliamps per LED, resulting in an illumination life of about 40-50 hours for seven such LED's lighted at once or about 150 hours where a single LED is lighted.

Each Nichia brand LED has an output beam width (bounded by its one-half intensity points) of 60 degrees. That is, a 50 per cent falloff in light output occurs at the edge of the 60 degree cone of light produced by each LED. The inventor has determined that by arranging a plurality of axes-parallel, unidirectional and adjacent high intensity LED's in an evenly spaced manner, an even unidirectional distribution of light is produced. For a user's field of view up to and exceeding about 40 feet in total darkness. For each high intensity LED, each cone of light is centered around the front face of each LED. It should be noted that since the light emitting centers of the LED's are spaced apart to form a general filled or non-filled polygon, the edges of the respective light cones are intended to overlap. The present close adjacency of the LED's has resulted in an even illumination field without dark spots the preferred illumination distance. The Nichia brand LED will deliver about 50% of its rated brightness at about 100 feet, which for warning purposes is adequate but for use by a user in a work field is generally not acceptably sufficient illumination. However, the present inventor has found that the plurality unidirection LED array with high intensity LED's delivers at 30-40 feet up to 80-90% of the LED's rated brightness for each LED with substantially identical field overlap illumination from the adjacent LED's. While the specific examples in the Figures include up to seven adjacent and unidirectioned LED's to provide for a wide range of conditions, as few as two such LED's will provide substantial benefits of the invention device.

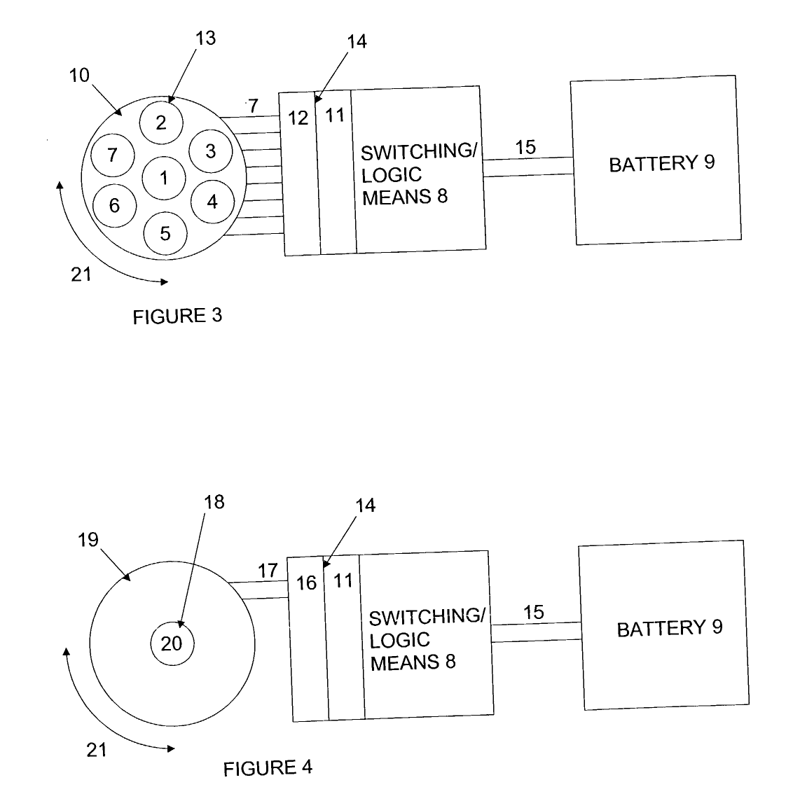

Referring now to FIGS. 3 and 4, the invention is described in more general terms. A plurality of LED's 13 are secured to an LED support 10. It is this support 10 that may be efficiently located close to and supportively with the housing for switching/logic means 8 (as in FIGS. 1 and 2) or electrical connections 7′ may comprise wires that connect individual LED's 1-7 with means 8 somewhat distant from the support 10. In a specific example, support 8 (as in one form the means 102 for LED's 103 in FIGS. 1 and 2) may be mounted to a supportive connection directly to a cap or hard hat such that the means 8 and battery 9 are located toward the back side of the headpiece (or strap configuration as in FIGS. 1 and 2) and the connections 7′ provide a wired connection thereto. Therefore, the invention assembly comprises a remote location for the means 8 and battery 9 from support 10. Means 8 may also comprise wireless transmission means and support 10 comprises wireless receiving means such that connections 7′ are made by infrared or radio transmission instead of by wire, thereby requiring a second battery to be associated with the support 10 for powering the LED's 13.

LED's 1-7 are preferably lighted at a separable switching action such as rotation of means 102 in the following lighting pattern: LED's 1-3 are lighted upon a first circuit power-up and LED's 4-7 are lighted sequentially upon each rotation of the means 102 about an arc of more than 1-2 millimeters. It is another embodiment of the present invention that LED 1 may be substituted with a filament, noble gas or halogen bulb so that the invention assembly comprises the option of having LED lighting or other type bulb lighting alone or in combination with each other, although in a particularly preferable embodiment a Xenon bulb is used in combination with the LED's of the invention. In FIG. 3, plug 12 and receptacle 11 form removable interface 14 such that the elements to the left of interface 14 are removable and electrically disconnectable from the elements to the right of interface 14. Thus, as shown in FIG. 4, the elements to the left of interface 14 are a new plug 16 electrically connected with the elements to the right of interface 14, whereby connections 17 connect the switching/logic means 8 and battery 9 to filament, noble gas or halogen bulb 20 in location 18 on parabolic reflector 19. The elements to the right of interface 14 may be duplicated such that one set of such elements are supported on a headpiece such as in FIGS. 1 and 2 and another set of such elements are supported in a handheld or wall mounted housing so the elements to the left of interface 14 in FIG. 3 may be movable from a headpiece to a handheld piece or to a wall mounted piece. A stationary mount such as on a wall may be used where long lasting emergency lighting is required.

Although seven LED's are shown in the Figures, it is intended that as few as two or as many as 20 or more LED's may be arranged such that sequential or all-at-once switching to battery power is formed thereby. The present invention departs from the prior art in having disclosed that LED lighting is in fact adequate for wide area lighting and is of such low power that extremely long battery life is given the user, in contrast to filament, noble or halogen bulbs whose power requirements cause batteries to give out in a few hours of use.

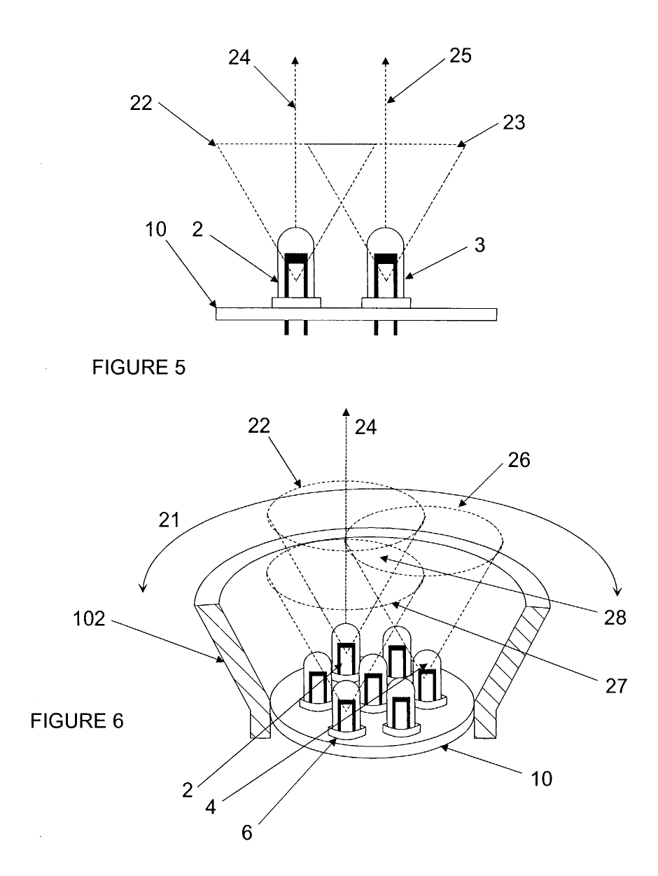

FIG. 5 shows adjacent LED's 2 and 3 on a support plate or surface 10 whereby the substantial (about 60 degrees and defining unidirectional axes 24 and 25) illumination cones 22 and 23 of LED's 2 and 3 respectively. It is intended that the invention LED's provide by original manufacturing means substantially all the reflectivity required for the invention device without needing substantial reflectivity on the surfaces of plate 10 or the inside surface of the cone of assembly 102 as shown in FIG. 6. The devices of FIGS. 1 and 2 in fact comprise black or very dark backgrounds so that a distant viewer may more easily see the LED's in a muted or low light condition.

As an alternate embodiment of the invention, the darkened concave spherical, parabolic and/or angled surfaces of the inside surface of the cone of assembly 102 may also in a preferred embodiment be metallized or made reflective thereby providing a very substantial improvement in illumination from the invention assembly.

FIG. 6 is a cutaway protective cove perspective view of the device of FIGS. 1 and 2 showing overlap of illumination cones 22, 26 and 27 for unidirectional and adjacent LED's 2, 4 and 6 respectively. The overlap region 28 increases to substantially the entire illumination cones of the invention LED's at about 1-2 feet from the LED's, such that an even illumination plane for the user is obtained with the plurality of invention LED's from about 1-2 feet to about 30-40 feet, where substantial decline in effective work illumination begins.

It is an object of the present invention to permit a recreational or industrial user of a headpiece mounted and battery powered light source to obtain adequate lighting for darkened areas while having over 30 hours of use with only the power from three AA type batteries.

It is another object of the present invention to permit a user to switch from LED lighting to filament, noble gas or halogen lighting in a single device with a battery source for power.

It is another object of the present invention to provide an LED lighted device for emergency flashing using red, green and/or blue LED's according to the above devices for signaling in darkened places the need for help.

It is another object of the present invention to include in an LED lighting device logic means that measure remaining battery power and reduce the number of lighted LED's according to a desired lighting period pre-set or settable by the user.

Another embodiment of the present invention comprises switching means so that the sequence of OFF/3 LED's lighted/5 LED's lighted/7 LED's lighted/OFF occurs by depression of a single button on a base part of the LED assembly. It has also been found that alkaline batteries that will typically supply the battery power for the invention assembly discharge according a less preferred manner where for a first period of 10-12 hours a relatively high power output occurs followed by a second period of 50-60 hours of appreciably reduced power output. That second period causes the illumination of the invention assembly to be noticeably reduced and less preferable to a user. Digital power control means are preferred between the battery power source and the LED's so that power delivery in the second period is increased substantially, optionally to the level achieved in the first period.

Some technical background is now provided for appreciation of the invention. A lumen is a unit of light output, equal to 1/(60*pi) of the light emitted by one square centimeter of ideal blackbody surface at the melting point of platinum. When the spectrum differs from that of a blackbody at the melting point of platinum, equate lumens by applying the official photopic function to the quantity of light at every wavelength present. One watt of light at any single wavelength (or in a very narrow band) is, in lumens, 681 times the official photopic function of that wavelength. Any eyeballs (or other light sensors) of spectral response deviating from that of the “official standard observer” could see as unequally bright light sources of equal lumens/candela and different spectral output. A “USA-usual” 100 watt, 120 volt, 750 hour “regular” (A19) lightbulb usually produces 1710 lumens. Lumens per watt is a measure of efficiency in converting electrical energy to light. Multiply this by the watts dissipated in the LED to get lumens. A white LED typically has a voltage drop of 3.4 volts at 20 mA and gets 0.068 watt at 20 mA. A candela is a lumen per steradian, or “beam candlepower”. The candela is a primarily defined metric unit, equal to 1/60 of the perpendicular/normal “candlepower” of one square centimeter of ideal blackbody surface at the melting point of platinum. So lumens are candelas times the beam coverage in steradians. Candelas are lumens divided by the beam coverage in steradians. Ideally, that is—assuming that all light is within the beam and the “candlepower” is constant within this beam. A steradian is 1/(4*pi) of a whole sphere or 1/(2*pi) of a hemisphere or about 3283 “square degrees”. To get steradians from the beam angle: Steradians=2*pi*(1−cos (0.5*(beam angle))). So if you determine the steradian beam coverage and multiply that by the candela figure (or 1/1000 of the millicandela figure), you get the lumen light output—very roughly! The beam is not uniform and it does not contain all of the light. Obtaining lumens from beam angle and candela can easily be in the +100/−50 percent range. Actual lumens are generally higher than predicted by this formula with smaller beam angles of 8 degrees or less since the nominal beam does not include a secondary “ring-shaped” “beam” that usually surrounds the main one.

The above design disclosures present the skilled person with considerable and wide ranges from which to choose appropriate obvious modifications for the above examples. However, the objects of the present invention will still be obtained by the skilled person applying such design disclosures in an appropriate manner.

I claim:

1. A method for lighting a user activity area comprising:
(a) a battery-powered LED assembly comprising three or more LED's each rated at 15 lumens per watt at 20 millamps or greater and mounted in a bottom part of an LED support which has walls extending outwardly and substantially conically from the bottom part thereby such that each of the LED's have illumination directional axes substantially parallel to each other and normal to the LED support;
(b) selection means for turning on or off each LED independently from the others in response to power saving for the battery power;
(c) adapting the LED assembly to be supported from a user's hand or head and causing a plurality of the LED's to be lighted;
(d) causing the selection means to turn on at least two of the LED's and thereby effectively illuminating a user activity area up to at least about 30 feet from the LED assembly.

2. The system of claim 1 wherein the LED's each operate with at least 5.6 candela with a 20 degree beam.

3. The system of claim 1 wherein the LED's each are gallium nitride or indium gallium nitride types.

4. The system of claim 1 wherein the selection means comprise a sequence of switches activated by physical motion of at least a part of the LED assembly.

5. The system of claim 4 wherein the LED support is rotatably mounted to a base part of the LED assembly.

6. The system of claim 5 wherein selection means comprise first contacts on the LED support are connected with the LED's on the LED support, second contacts connected with battery power are located on the base part, and the first and second contacts are located such that rotation of the LED support relative to the base part causes the LED's to light sequentially.

7. The system of claim 1 wherein the selection means comprise input and setpoint means for establishing a minimum operation time for illuminating the user area with lighted LED's, digital means sensing power level in the battery power source and switching means for turning off one or more lighted LED's such that the minimum operation time is obtained without exhausting battery power.

8. The system of claim 7 wherein switching means comprise means for switching off one LED at a time with a pre-set delay time between each LED switched off such that a user is warned by gradual reduction in illumination that battery power will be exhausted at the minimum operation time.

9. A device for lighting a user activity area comprising:
(a) a battery-powered LED assembly comprising three or more LED's each rated at 15 lumens per watt at 20 millamps or greater and mounted in a bottom part of an LED support such that each of the LED's have illumination directional axes substantially parallel to each other and normal to the LED support;
(b) selection means for turning on or off each LED;
(c) adapting the LED assembly to be supported from a user's hand or head.

10. The device of claim 1 wherein the LED's each operate with at least 5.6 candela with a 20 degree beam.

11. The device of claim 10 wherein the LED's each are gallium nitride or indium gallium nitride types.

12. The device of claim 11 wherein the selection means comprise a sequence of switches activated by physical motion of at least a part of the LED assembly.

13. The device of claim 12 wherein the LED support is rotatably mounted to a base part of the LED assembly.

14. The device of claim 13 wherein selection means comprise first contacts on the LED support are connected with the LED's on the LED support, second contacts connected with battery power are located on the base part, and the first and second contacts are located such that rotation of the LED support relative to the base part causes the LED's to light sequentially.

15. The device of claim 14 wherein the selection means comprise input and setpoint means for establishing a minimum operation time for illuminating the user area with lighted LED's, digital means sensing power level in the battery power source and switching means for turning off one or more lighted LED's such that the minimum operation time is obtained without exhausting battery power.

16. The device of claim 15 wherein switching means comprise means for switching off one LED at a time with a pre-set delay time between each LED switched off such that a user is warned by gradual reduction in illumination that battery power will be exhausted at the minimum operation time.

17. The device of claim 16 wherein the LED support is adapted to be removable from the base part and replaceable with a non-LED lighting source assembly comprising a non-LED lighting source from the group consisting of incandescent bulbs, halogen bulbs and noble gas bulbs.
